(19) United States
(12) Patent Application Publication
(10) Pub. No.: US 2011/0258223 A1
(43) Pub. Date: Oct. 20, 2011

(54) VOICE-BASED MOBILE SEARCH APPARATUS AND METHOD

(75) Inventors: Soo-Jong Lim, Daejeon (KR); Hyo-Jung Oh, Daejeon (KR); Jeong Heo, Daejeon (KR); Hyun-Ki Kim, Daejeon (KR); Yeo-Chan Yoon, Seoul (KR); Yi-Gyu Hwang, Daejeon (KR); Mi-Ran Choi, Daejeon (KR); Chang-Ki Lee, Daejeon (KR); Pum-Mo Ryu, Daejeon (KR); Chung-Hee Lee, Daejeon (KR); Myung-Gil Jang, Daejeon (KR)

(73) Assignee: Electronics and Telecommunications Research Institute, Daejeon (KR)

(21) Appl. No.: 13/086,067

(22) Filed: Apr. 13, 2011

(30) Foreign Application Priority Data
Apr. 14, 2010 (KR) 10-2010-0034129

(51) Int. Cl. G06F 17/30

(52) U.S. Cl. 707/769; 707/E17.014

(57) ABSTRACT

The present invention relates generally to a voice-based mobile search apparatus and method, and, more particularly, to a voice-based mobile search apparatus and method, which can present optimized search results suitable for a mobile status while allowing a user to conveniently use a search service in a mobile environment. The voice-based mobile search apparatus according to the present invention includes a voice recognition unit for recognizing a user's voice transferred through a mobile terminal and then receiving a query. A status information collection unit collects status information of the mobile terminal and profile information of the user. An answer search unit searches a knowledge base based on the query, and extracts short answers matching the query. An answer provision unit processes the short answers in conformity with the status information of the mobile terminal and the profile information of the user, and provides the processed short answers.

### CROSS REFERENCE TO RELATED APPLICATION

This application claims the benefit of Korean Patent Application No. 10-2010-0034129 filed on Apr. 14, 2010, which is hereby incorporated by reference in its entirety into this application.

### BACKGROUND OF THE INVENTION

1. Technical Field

The present invention relates generally to a voice-based mobile search apparatus and method, and, more particularly, to a voice-based mobile search apparatus and method, which can present optimized search results suitable for a mobile status while allowing a user to conveniently use a search service in a mobile environment.

2. Description of the Related Art

Generally, services or the like intended to use voice as an input means or to provide convenience to a user based on the status information of the user in a mobile environment have been used.

Among these services intended to provide convenience, a service which recommends a specific place is configured to show all registered places within a predetermined range on the basis of a current location by using the location information of a mobile terminal equipped with a Global Positioning System (GPS) or the location information of a communication company such as SKT, KTF, or LGT. In this case, the service is convenient in that the user does not need to separately input location information, but there is a disadvantage in that the user's desired information is not considered and only information provided by a service provider must be unilaterally viewed.

Further, in the case of a conventional typical mobile search, since the User Interface (UI) of the web search engine of the existing wired Internet merely changes in conformity with the mobile environment, there are many cases where the same search results are presented to all users without taking into consideration status information such as the location of the user or the time used by the user.

Meanwhile, there is a conventional service for adopting voice recognition that aims to overcome the problems related to inconvenience of information input. However, the conventional service which uses voice recognition is also inconvenient because a user must undergo an identification procedure involving making a call and manipulating a keypad several times so as to use the service. Further, such a conventional service is problematic because a burden of additional expenses that a voice call may incur.

### SUMMARY OF THE INVENTION

Accordingly, the present invention has been made keeping in mind the above problems occurring in the prior art, and an object of the present invention is to provide a mobile search apparatus and method, which receive a query from a user who uses a search service in a mobile environment using voice recognition technology by selecting a menu once, and which optimize search results using the received query and status information, such as location information detected by the mobile terminal of the user, and present the optimized search results to the user.

Another object of the present invention is to provide a mobile search apparatus and method, which allow a user to conveniently input a query using server-client type voice recognition technology in a mobile environment, process search results matching the query according to status information, and provide the search results in the form of short answers.

In order to accomplish the above objects, the present invention provides a voice-based mobile search apparatus, including a voice recognition unit for recognizing a user's voice transferred through a mobile terminal to receive a query; a status information collection unit for collecting status information of the mobile terminal and profile information of the user; an answer search unit for searching a knowledge base DB based on the query to extract short answers matching the query; and an answer provision unit for processing the short answers in conformity with the status information of the mobile terminal and the profile information of the user to provide the processed short answers.

Further, the present invention provides a voice-based mobile search method, including recognizing a user's voice transferred through a mobile terminal and then receiving a query; collecting status information of the mobile terminal and profile information of the user; searching a knowledge base DB based on the query, and extracting short answers matching the query; and processing the short answers in conformity with the status information of the mobile terminal and the profile information of the user, and providing the processed short answers.

As described above, according to the present invention, there is an advantage in that when a search is intended to be performed in a mobile terminal where it is inconvenient to input information, the most natural means, that is, speech, is used, and then convenience can be provided.

Further, the present invention presents only short answers (or correct answers) rather than documents as search results, thus overcoming disadvantages caused by a small window implemented on a mobile terminal.

The results of short answers presented in the small window are also optimized in conformity with the user's status, thus providing improved user's convenience and satisfaction.

This convenience consequently allows the effects of the activation of mobile search services to be predicted.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a system to which a voice-based mobile search method according to the present invention is applied;

FIG. 2 is a block diagram showing a voice-based mobile search apparatus according to the present invention; and

FIG. 3 is a flowchart showing the voice-based mobile search method according to the present invention.

### DESCRIPTION OF THE PREFERRED EMBODIMENTS

Hereinafter, embodiments of the present invention will be described in detail with reference to the attached drawings.

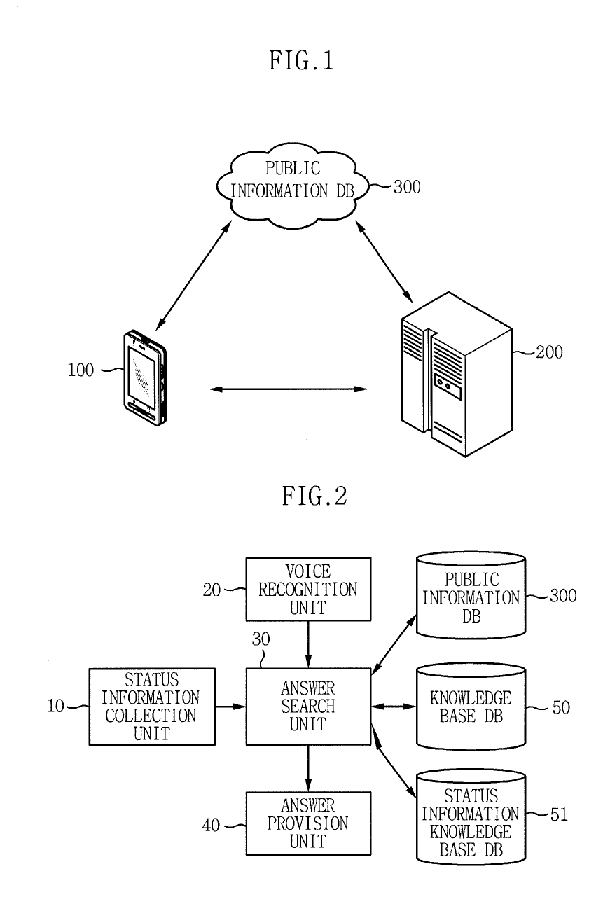

FIG. 1 is a diagram showing a system to which a voice-based mobile search method according to the present invention is applied.

Referring to FIG. 1, the system to which the voice-based mobile search method according to the present invention is applied includes a mobile terminal 100 and a server 200. The system is configured to present optimized search results in conformity with a mobile status while allowing a user to conveniently use a search service in a mobile environment.

The mobile terminal 100 is provided with an interface capable of providing intelligent search menus to the user, and is configured to receive a query required for a search using the user's voice or a key input method. Further, the mobile terminal 100 may include a mobile phone, a smart phone, or other portable devices. The mobile terminal 100 communicates with the server 200 in a wireless communication manner.

The server 200 is configured to allow the user to conveniently make a query using voice recognition technology in a mobile environment, and to provide optimized search results based on the location of the user to the user. A search procedure performed by the server 200 includes the step of extracting the location of the user and status information, the step of recognizing a voice and then receiving a query, the step of searching for answers matching the query of the user, and the step of optimizing and presenting found answers in conformity with the user's status information.

In the present invention, the server 200 processes information according to a server-client concept together with the mobile terminal 100. Further, the server 200 receives the user's query using voice recognition or the like, and provides resulting information by performing a search matching the query. That is, in the present invention, voice recognition is adopted, so that the user can check the results of voice recognition in the form of a character sequence and immediately perform a search without having a burden of an additional call or additional input. Further, optimal search results can be presented in consideration of status information such as the location information and time of the user.

Public information DB 300 includes information such as typical web information. The server 200 searches the public information DB 300 when it is intended to provide information other than answers to the query, which will be provided to the user.

FIG. 2 is a block diagram showing a voice-based mobile search apparatus according to the present invention. In the description, a description will be made using the case where the voice-based mobile search apparatus of the present invention is the server shown in FIG. 1 as an embodiment.

Referring to FIG. 2, the server 200 includes a status information collection unit 10, a voice recognition unit 20, an answer search unit 30, and an answer provision unit 40. As described above, the server 200 is configured to present optimized search results in conformity with a mobile status while allowing the user to conveniently use a search service in the mobile environment.

The server 200 further includes a knowledge base DB 50 which includes various answer candidates that have been previously constructed, and a status information knowledge base DB 51 based on the status information of the user.

Here, the server 200 is configured to use the above-described public information DB 300 when searching an area deviating from the knowledge base DB 50 for answers.

The status information collection unit 10 collects the status information of the mobile terminal 100 and the profile information of the user. The status information collection unit 10 collects status information including at least one of a location and time through the mobile terminal 100 when the user requests a search. For example, the status information collection unit 10 can collect the location of the user using a Global Positioning System (GPS) module or the location information of a communication company. Furthermore, the status information collection unit 10 can also detect the current time, at which the user attempts to make a search, via the mobile terminal 100. Further, the status information collection unit 10 collects the profile information of the user which has been previously stored. The user's profile information refers to information in which basic user information such as the age or gender of the user is stored in the form of a personal profile under an agreement with the user at the time of subscribing to the service.

The voice recognition unit 20 recognizes the user's voice transferred through the mobile terminal 100 and then receives a query. When the user inputs a desired search query by voice, the voice recognition unit 20 receives relevant voice data transferred via the mobile terminal 100. Further, the voice recognition unit 20 recognizes the received voice data as a character sequence, and then receives the user's query.

In this case, the voice recognition unit 20 determines a final query after performing the procedure of recognizing the user's query as a character sequence via the mobile terminal 100 and accepting the user's confirmation of the recognition results.

The answer search unit 30 searches the knowledge base DB 50 based on the query, and extracts short answers matching the query. The answer search unit 30 performs a search based on the determined query, and primarily uses the knowledge base DB 50 in which possible answers to expected queries that can be made by users are arranged into a database (DB) in advance.

Further, the answer search unit 30 preferably searches the public information DB 300, for example, document content on the web, and processes search results in the same form as that of the knowledge base DB 50, in order to search an area other than the knowledge base DB 50 for answers.

The answer provision unit 40 processes short answers in conformity with the status information of the mobile terminal 100 and the profile information of the user, and provides the processed information to the mobile terminal 100. The answer provision unit 40 finally processes the search results into answers suitable for the status of the user who made the query, with reference to the status information knowledge base DB 51, and provides the final answers to the user through the mobile terminal 100. Here, the status information knowledge base DB 51 includes the status information of the mobile terminal 100 and the profile information of the user. In this way, the answer provision unit 40 immediately presents the user's desired short answers in consideration of the small window of the mobile terminal 100.

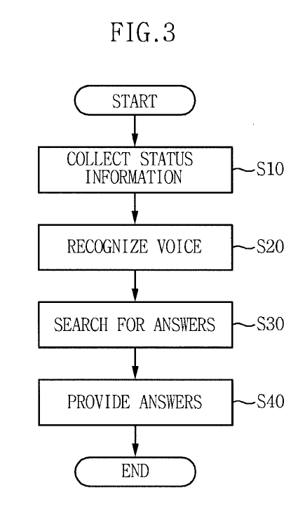

FIG. 3 is a flowchart showing a mobile search method according to the present invention.

Referring to FIG. 3, the status information collection unit 10 collects the status information of the mobile terminal 100 and the profile information of the user at step S10. That is, the status information collection unit 10 collects information suitable for the current status of the user. For example, the user's location and usage time which vary dynamically are collected. Further, gender and age information which rarely vary is collected in advance at the time when the user initially uses the service, and is stored in advance in the mobile terminal 100. Such information is used as user characteristic information when answers found by the answer provision unit 40 are optimized in conformity with the user's status, that is, when the status information knowledge base DB 51 is used.

Next, the voice recognition unit 20 recognizes the user's voice transferred through the mobile terminal 100 and then receives a query at step S20. The voice recognition unit 20 allows the user to conveniently make a query used for a search by voice. For example, when the user requests voice recognition, the voice recognition unit 20 can recognize the voice, and can then present the voice to the user in the form of a character sequence. The character sequence query recognized in this way is used as the input of the answer search unit 30.

In this case, the voice recognition unit 20 may omit a voice recognition step and may receive and use the query which has been directly input using the keypad of the mobile terminal 100 when the user is in a situation where he or she has difficulty in speaking.

Further, when the voice recognition unit 20 presents the state of query input to the user, the following procedures can be included. A first procedure is a method of immediately using the results of voice recognition as the input of the answer search unit 30 without accepting the user's confirmation of the results of the voice recognition. A second procedure is a method of allowing the user to confirm the results of the voice recognition and correct the results of the voice recognition if necessary, and of using the corrected results of the voice recognition as the input of the answer search unit 30.

Then, the answer search unit 30 searches the knowledge base DB 50 based on the query, and then extracts short answers matching the query at step S30. That is, the answer search unit 30 functions to extract only short answers using the input user query. For example, when the user desires to search for “neighboring favorite restaurants with a childcare center,” a typical search engine searches various documents for documents having keywords such as ‘childcare center’ or ‘favorite restaurant’, and presents the found documents to the user. In this case, the user has the inconvenience of having to load those documents and read the contents thereof in an inconvenient and low-speed mobile Internet environment. However, in this case, the present invention presents desired search results to the user in the form of answers such as ‘the Coex branch of Chuncheon Spicy Grilled Chicken’ without requiring additional actions from the user.

Methods of extracting short answers in the answer search unit 30 will be described below. First, there is a method using the knowledge base DB 50. That is, the knowledge base DB 50 is a scheme in which possible answers to expected queries that can be made by the user are arranged into a knowledge base in advance, and this scheme exhibits better effects when a target area to which queries are desired to be applied is designated. Second, there is a method in which when the user requests answers deviating from an expected range, answers are extracted in real time from the public information DB 300, that is, the typical web, using information extraction technology and are then presented.

Finally, the answer provision unit 40 processes the short answers in conformity with the status information of the mobile terminal 100 and the profile information of the user, and provides the processed short answers at step S40. The answer provision unit 40 may function to reorder the short answers extracted by the above-described answer search unit 30 according to the user's status.

In this case, since the answer search unit 30 does not use any information other than the user's queries, the same results are presented to all users if they make the same query. However, these may not be optimized answers from the standpoint of the mobile terminal 100 having plentiful status information of the user. The answer provision unit 40 reorders the results of the answers using the information collected by the answer collection unit 30, and may remove relevant answers from the results of the answers if necessary. For example, this procedure may be performed in such a way that when the user makes a query “favorite restaurants with a childcare center” near Seoul station at lunch time, found favorite restaurants which match the query are reordered in the sequence of closeness to Seoul station, and that among the found restaurants, restaurants in which a childcare center is operated only in the evening are excluded from the list of the answers.

Meanwhile, the procedure for recognizing a voice at the above-described step S20 may include the following steps. First, after the mobile terminal 100 merely records a voice, the recorded voice data is transmitted to the server 200. Then, after the voice recognition unit 20 of the server 200 performs a voice recognition function, it presents only the results of voice recognition to the user of the mobile terminal 100, and accepts the user's confirmation of the results of the voice recognition. This is implemented by adopting a server-client type scheme in consideration of limited computing power of the mobile terminal 100. Second, when there is sufficient computing power of the mobile terminal 100, the mobile terminal 100 includes a voice recognition function therein, and then performs all voice recognition functions. Then, the voice recognition unit 20 receives voice-recognized data from the mobile terminal 100, and processes the voice-recognized data as the results of the recognition of the query from the user.

As described above, according to the present invention, there is an advantage in that when a search is intended to be performed in a mobile terminal where it is inconvenient to input information, the most natural means, that is, speech, is used, and then convenience can be provided.

Further, the present invention presents only short answers rather than documents as search results, thus overcoming disadvantages caused by a small window implemented on a mobile terminal.

The results of short answers presented in the small window are also optimized in conformity with the user's status, thus providing improved user's convenience and satisfaction.

This convenience consequently allows the effects of the activation of mobile search services to be predicted.

As described above, optimal embodiments have been disclosed in the drawings and the specification. Although specific terms have been used here, these are only intended to describe the present invention and are not intended to limit the meanings of the terms or to restrict the scope of the present invention as disclosed in the accompanying claims. Therefore, those skilled in the art will appreciate that various modifications and other equivalent embodiments are possible from the above embodiments. Therefore, the scope of the present invention should be defined by the technical spirit of the accompanying claims.

What is claimed is:

1. A voice-based mobile search apparatus, comprising:
a voice recognition unit for recognizing a user's voice transferred through a mobile terminal to receive a query;
a status information collection unit for collecting status information of the mobile terminal and profile information of the user;
an answer search unit for searching a knowledge base DB based on the query to extract short answers matching the query; and
an answer provision unit for processing the short answers in conformity with the status information of the mobile terminal and the profile information of the user to provide the processed short answers.

2. The voice-based mobile search apparatus of claim 1, wherein the answer provision unit determines the user's status according to the status information of the mobile terminal and the profile information of the user, and orders or filters answers to be provided to the user based on results of the determination.

3. The voice-based mobile search apparatus of claim 1, wherein:
the status information of the mobile terminal includes at least one of a location and time of the mobile terminal, and
the profile information of the user is personal information including at least one of age and gender of the user.

4. The voice-based mobile search apparatus of claim 1, wherein the answer search unit searches for information matching the query, and extracts short answers to be presented to the user using the information.

5. The voice-based mobile search apparatus of claim 1, wherein:
the knowledge base DB comprises answer candidates for expected queries, and
the answer search unit primarily extracts short answers from the answer candidates in relation to the user's query.

6. The voice-based mobile search apparatus of claim 5, wherein the answer search unit searches public information DB when the user's query does not fall within a range of the expected queries.

7. The voice-based mobile search apparatus of claim 1, wherein the voice recognition unit completes input of the query after accepting the user's confirmation of the query via the mobile terminal.

8. The voice-based mobile search apparatus of claim 1, wherein the voice recognition unit receives data obtained by recognizing the user's voice through the mobile terminal.

9. A voice-based mobile search method, comprising:
recognizing a user's voice transferred through a mobile terminal and then receiving a query;
collecting status information of the mobile terminal and profile information of the user;
searching a knowledge base DB based on the query, and extracting short answers matching the query; and
processing the short answers in conformity with the status information of the mobile terminal and the profile information of the user, and providing the processed short answers.

10. The voice-based mobile search method of claim 9, wherein the processing and providing is configured to determine the user's status according to the status information of the mobile terminal and the profile information of the user, and to order or filter answers to be provided to the user based on results of the determination.

11. The voice-based mobile search method of claim 9, wherein:
the status information of the mobile terminal includes at least one of a location and time of the mobile terminal, and
the profile information of the user is personal information including at least one of age and gender of the user.

12. The voice-based mobile search method of claim 9, wherein the extracting the short answers comprises:
searching for information matching the query; and
extracting short answers to be presented to the user using the information.

13. The voice-based mobile search method of claim 9, wherein:
the knowledge base DB comprises answer candidates for expected queries, and
the extracting the short answers is configured to primarily extract short answers from the answer candidates in relation to the user's query.

14. The voice-based mobile search method of claim 13, wherein the extracting the short answers is configured to search public information DB when the user's query does not fall within a range of the expected queries.

15. The voice-based mobile search method of claim 9, wherein the receiving the query is configured to complete input of the query after accepting the user's confirmation of the query via the mobile terminal.

16. The voice-based mobile search method of claim 9, wherein the receiving the query is configured to receive data obtained by recognizing the user's voice through the mobile terminal.
